(19) United States
(12) Patent Application Publication
(10) Pub. No.: US 2015/0011920 A1
(43) Pub. Date: Jan. 8, 2015

(54) SYSTEM FOR DYNAMICALLY GENERATING HYPER-G FORCES TO RELOCATE DETACHED AND IMPEDED CANALITHS IN THE INNER EAR

(71) Applicants: Ian Purcell, San Diego, CA (US); Yinhong Qu, Tianjin (CN); Yingxin Li, Tianjin (CN)

(72) Inventors: Ian Purcell, San Diego, CA (US); Yinhong Qu, Tianjin (CN); Yingxin Li, Tianjin (CN)

(21) Appl. No.: 13/933,763

(22) Filed: Jul. 2, 2013

(51) Int. Cl. A61H 1/00

(52) U.S. Cl. CPC A61H 1/005
USPC 601/112

(57) ABSTRACT

A motorized system for selectively moving a patient to reposition canaliths in the patient's inner ear to treat a balance disorder includes a base member, a patient support and a connecting assembly. The patient support is mounted on the connecting assembly and the connecting assembly is engaged with the base member. In one embodiment, the connecting assembly can include a substantially U-shaped loop member and the patient support is a chair. One motor rotates the patient support (and patient) about a first axis relative to the connecting assembly. Another motor rotates the connecting assembly (and patient support) relative to the base member about a second axis that is perpendicular to the first axis. With this arrangement, the motors move the patient support (and patient) at relatively high angular velocities, from one patient position to the next, in accordance with a predetermined protocol, such as the well-known Epley maneuver.

### FIELD OF THE INVENTION

The present invention pertains generally to the treatment of balance disorders. More particularly, the present invention pertains to systems and methods for treating balance disorders that are caused by complications in the inner ear of a patient. The present invention is particularly, but not exclusively, useful as a system that can be used to treat a balance disorder by repositioning detached canaliths in the inner ear of a patient.

### BACKGROUND OF THE INVENTION

It is widely understood there is a mechanism located in a person's inner ear that provides the individual with his/her sense of balance. Anatomically, this mechanism is made up of clusters of sensory hair cells that are specifically oriented and aligned inside the inner ear. Further, each hair cell in a cluster includes an otolith (i.e. a “stone” or a “crystal”) which is coupled with the hair cell.

In their operation, clusters of the balance sensing mechanism sense gravity and linear accelerations as they are experienced by the individual. To do this, some clusters are aligned in the utricle with a generally horizontal orientation (i.e. in the axial plane). Other clusters are aligned in the saccule with a generally vertical orientation (i.e. the parasagittal plane). Within this structure, whenever there are changes in the forces acting on the otoliths, they are accelerated relative to the hair cell. These accelerations (i.e. force changes) are then transmitted via the hair cell to the brain for the purposes of providing a sensory perception of balance.

For any number of reasons, an otolith (crystal) can become decoupled from its hair cell (e.g. disease, age, or trauma). In its decoupled or detached condition, the formerly called otoliths are thereafter more specifically referred to as “canaliths.” In the event, the canaliths remain unrestrained inside the canals of the inner ear where they are capable of being disruptive in a manner that leads to balance disorders.

Heretofore, the most commonly used technique for alleviating or avoiding the disruptive effects of loose canaliths in the inner ear has been to perform specified head movements, such as the Dix Hallpike Maneuver. The intent here has been to reposition the canaliths to other locations in the inner ear where their adverse consequences are effectively nullified. It can happen however, that conditions inside the inner ear may hinder or impede the movement of canaliths through the canals. In particular, such an obstruction may result as canaliths “clump” together, and/or “stick” to the walls of the canals.

In light of the above it is an object of the present invention to provide a system and method for repositioning detached otoliths (i.e. canaliths) in the inner ear of a patient to obviate a balance disorder. Another object of the present invention is to treat a balance disorder by rapidly moving the head of a patient in accordance with a predetermined protocol to generate elevated forces (i.e. hyper-G forces) inside the canals of the inner ear that will move and reposition, otherwise immobile, canaliths that have been refractory to standard repositioning protocols. Still another object of the present invention is to provide a system and method for relocating canaliths inside the inner ear of a patient to obviate a balance disorder that is easy to use and comparatively cost effective.

### SUMMARY OF THE INVENTION

In accordance with the present invention, a system for repositioning canaliths in the inner ear of a patient to treat a balance disorder includes a base member, a patient support and a connecting assembly. Also for the system, motors are included to move the patient support (and patient) at relatively high angular velocities, from one patient position to the next, in accordance with a predetermined protocol such as the so-called Epley maneuver.

In more structural detail, the patient support is mounted on the connecting assembly and the connecting assembly is engaged with the base member. In one embodiment, the connecting assembly can include a substantially U-shaped loop member that has a first end and a second end. With this arrangement, the system defines a first rotation axis that extends through the first and second ends of the loop member. Specifically, a motor can be affixed to one end of the loop member and a mount affixed to the other end of the loop member. The patient support is positioned between the ends of the loop member and operably attached to both the mount and motor to allow the patient support to be rotated through selected angles, θ₁, about the first axis by the motor. In more quantitative terms, it is envisioned for the present invention that the motor will rotate the patient support (and patient) through a selected angle, θ₁, about the first axis at an angular velocity, ω₁, that is in the range of about 20 to 50 revolutions per minute (rpm).

The patient support (and patient) can also be rotated about a second axis that is perpendicular to the first axis. To provide this rotation, a motor is mounted on the base member having a motor shaft aligned with the second axis. A swivel joint is also mounted on the base member and positioned on the second axis. The motor shaft passes through the swivel joint and engages the loop member at an attachment point that is established on the loop member midway between the ends of the loop member. This arrangement allows the patient support to be rotated through selected angles, θ₂, about the second axis by the motor. In more quantitative terms, it is envisioned for the present invention that the motor will rotate the patient support (and patient) through a selected angle, θ₂, about the second axis at an angular velocity, ω₂, that is in the range of about 20 to 50 revolutions per minute (rpm).

Also for the system of the present invention, a controller is provided for selectively activating the motors to rotate the patient support (and patient) about the first and second axis and relative to the base member. Typically, the patient is moved through a sequence of positions by the system in accordance with a predetermined protocol (such as the Epley maneuver protocol). During the maneuver, to move the patient from one position to the next, one or both of the motors are activated to selectively rotate the patient through appropriate angles θ₁, θ₂, at respective angular velocities ω₁ and ω₂. A computer can be connected with the controller to execute a set of programmed instructions (i.e. software code) to operate the system in accordance with the predetermined protocol.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a system for repositioning canaliths in the inner ear of a patient to treat a balance disorder in accordance with the present invention;

FIG. 2 is a schematic diagram showing a control architecture for the system shown in FIG. 1; and

FIG. 3 is a flowchart illustrating a process for using the system shown in FIG. 1 to reposition canaliths in the inner ear of a patient to treat a balance disorder.

### DESCRIPTION OF THE PREFERRED EMBODIMENTS

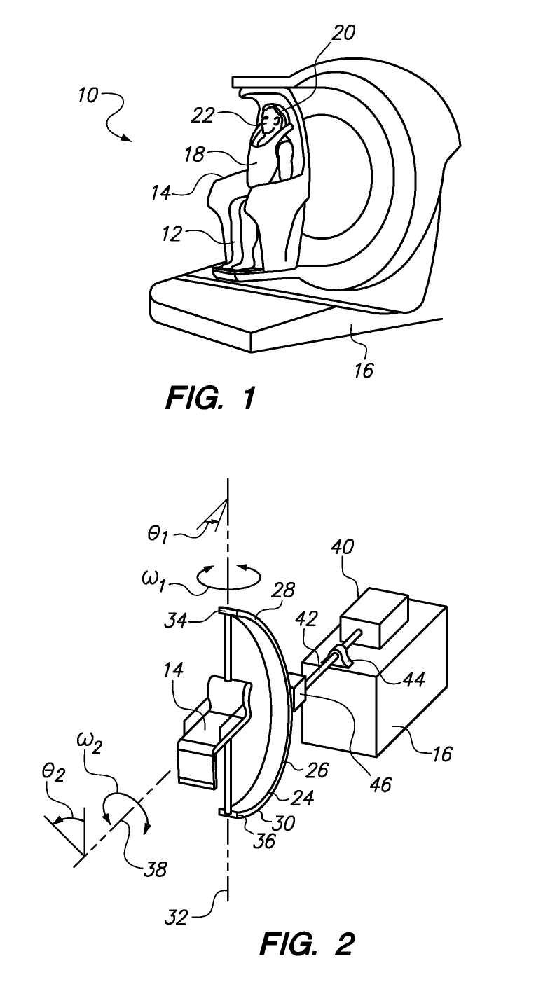

Referring initially to FIG. 1, a system 10 for repositioning canaliths in the inner ear of a patient 12 to treat a balance disorder is shown. As shown, the system 10 can include a patient support 14 that is moveable relative to a base member 16. Specifically, as detailed further below, the system 10 can be operated to move the patient support 14 (and patient 12) at relatively high angular velocities, from one patient position to the next, in accordance with a predetermined protocol, such as the so-called Epley maneuver or a canalith repositioning maneuver.

For the system 10 shown in FIG. 1, the patient support 14 can include a chair and can include various restraints 18, such as a seat belt and foot rest, to affix the patient 12 to the patient support 14 during the high angular velocity movements contemplated herein. In addition, as shown, the patient support 14 can include a headrest 20 for keeping the head 22 of the patient 12 at a fixed orientation relative to the patient's body during the movements described herein.

FIG. 2 shows the system 10 with shrouds removed to more clearly reveal the inner system components. As shown, the system 10 includes a connecting assembly 24 which attaches the patient support 14 to the base member 16. In more detail, FIG. 2 shows that the connecting assembly 24 can include a substantially U-shaped loop member 26 that has a first end 28 and a second end 30. With this arrangement, the system 10 defines a first rotation axis 32 that extends through the first end 28 and second end 30 of the loop member 26, as shown. FIG. 2 further shows that a motor 34 can be affixed to the first end 28 of the loop member 26 and a mount 36 can be affixed to the second end 30. With this cooperative interaction of structure, the patient support 14 is positioned between the ends 28, 30 of the loop member 26 and operably attached to both the mount 36 and motor 34 to allow the patient support 14 to be rotated about the first axis 32 by the motor 34. In more quantitative terms, it is envisioned for the present invention that the motor 34 will be sized and designed to rotate the patient support 14 (and patient 12 shown in FIG. 1) about the first axis 32 through a selected angle, θ₁, at an angular velocity, ω₁, that is in the range of about 20 to 50 revolutions per minute (rpm). Specifically, this angular velocity, ω₁, will be achieved as patient 12 is maneuvered from one patient position to the next, in accordance with a predetermined protocol, as described herein.

FIG. 2 also shows that the patient support 14 (and patient 12 shown in FIG. 1) can also be rotated about a second axis 38 which, as shown, can be substantially perpendicular to the first axis 32. To provide this rotation, FIG. 2 shows that a motor 40 is mounted on the base member 16 having a motor output shaft 42 that is aligned with the second axis 38. A swivel joint 44 is also mounted on the base member 16 and positioned on the second axis 38. The motor shaft 42 passes through the swivel joint 44 and engages the loop member 26 at an attachment point 46 that is established on the loop member 26 midway between the ends 28, 30 of the loop member 26. This structural arrangement allows the patient support 14 to be rotated through a selected angle, θ₂, about the second axis 38 by the motor 40. In more quantitative terms, it is envisioned for the present invention that the motor 40 will be sized and designed to rotate the patient support 14 (and patient 12 shown in FIG. 1) about the second axis 38 and through a selected angle, θ₂, and at an angular velocity, ω₂, that is in the range of about 20 to 50 revolutions per minute (rpm). Specifically, this angular velocity, ω₂, will be achieved as patient 12 is maneuvered from one patient position to the next, in accordance with a predetermined protocol, as described herein.

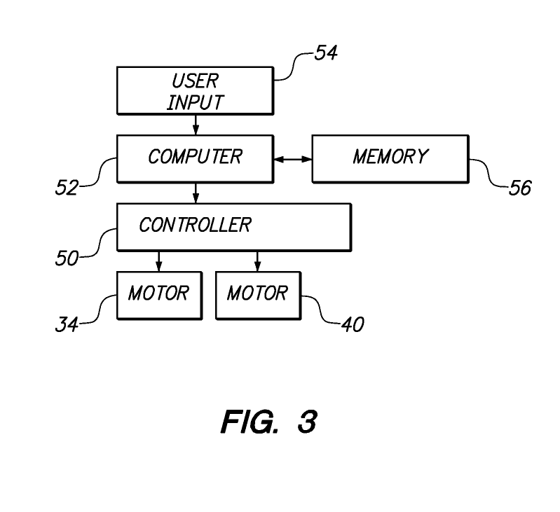

As best seen in FIG. 3, a controller 50 is provided for selectively activating the motors 34, 40 to rotate the patient support 14 (see FIG. 2) about the axes 32, 38. FIG. 3 also shows that a computer 52 can be connected with the controller 50 to execute a set of programmed instructions (i.e. software code) to activate the motors 34, 40 and move the patient 12 in accordance with the predetermined protocol. User input terminal 54 can be used to input these instructions and the instructions can be saved in computer memory 56 for access by the computer 52.

Typically, the patient 12 shown in FIG. 1 is moved through a sequence of positions by the system 10 in accordance with a predetermined protocol. The maneuver, such as the Dix-Hallpike maneuver, can be used to diagnose a balance order and/or a maneuver, such as the Epley maneuver protocol, can be used to treat a balance disorder. For purposes of discussion, and with reference to FIG. 2, a typical maneuver performed by the system 10 may place the patient's head 22 into a sequence of orientations (θ₁, θ₂) corresponding to head orientations achieved by the protocol set forth below.

FIG. 2 shows the patient support 14 initially positioned at θ₁, =0°, θ₂=0°. For purposes of the present invention, to start a protocol with the patient in the patient support 14, the patient is just rotated 90° to an initial position (θ₁, =90°, θ₂=0°. The following sequence then simulates the maneuver:

1. patient has head centered (θ₁, =90°, θ₂=0°);

2. patient sits with head 45 degrees to the right (θ₁, =45°, θ₂=0°);

3. patient lays back with head 45 degrees to the right and held in approximately 20 degrees of extension (θ₁, =45°, θ₂=110°);

4. patient returns with head centered (θ₁, =90°, θ₂=0°);

5. patient sits with head 45 degrees to the left (θ₁, =135°, θ₂=0°);

6. patient lays back with head 45 degrees to the left and held in approximately 20 degrees of extension (θ₁, =135°, θ₂=110°); and

7. patient sits back up with head centered (θ₁, =90°, θ₂=0°).

During the maneuver, involuntary eye movement (Nystagmus) can be monitored by the clinician. In some cases, the patient 12 can wear a goggle system (not shown) during the procedure to assist the clinician in diagnosing a balance disorder. For example, the patient 12 can wear a goggle system as described and claimed in co-pending, co-owned U.S. patent application Ser. No. 13/929,572, filed Jun. 27, 2013, titled “Goggles for Emergency Diagnosis of Balance Disorders,” the entire contents of which are hereby incorporated by reference herein.

While the particular System for Dynamically Generating Hyper-G Forces to Relocate Detached And Impeded Canaliths in the Inner Ear as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for repositioning canaliths in the inner ear of a patient to treat a balance disorder, the system comprising:
a base member;
a connecting assembly engaged with the base member;
a patient support mounted on the connecting assembly for fixedly holding the patient on the patient support, with the spine of the patient oriented substantially parallel to a first rotation axis, wherein the first rotation axis is defined by the connecting assembly;
a first rotation means mounted on the connecting assembly for rotating the patient support about the first rotation axis at an angular velocity, ω₁, greater than 20 revolutions per minute (rpm);
a second rotation means mounted on the base member for rotating the connecting assembly and the patient support about a second rotation axis at an angular velocity, ω₂, greater than 20 rpm; and
a controller for selectively activating the first rotation means, and the second rotation means, to move the patient, together with the patient support, relative to the base member, in accordance with a predetermined protocol, for relocating canaliths in the inner ear of the patient to treat a balance disorder.

2. A system as recited in claim 1 wherein the connecting assembly comprises:
a substantially U-shaped loop member having a first end and a second end with an attachment point established therebetween, wherein the first end and the second end of the loop member define the first rotation axis; and
a swivel drive for interconnecting the loop with the base member at the attachment point on the loop, wherein the swivel drive is located on the second rotation axis.

3. A system as recited in claim 2 wherein the first rotation means comprises:
a motor affixed to the first end of the loop member for interaction with the patient support; and
a mount affixed to the second end of the loop member to enable a rotation of the patient support around the first rotation axis.

4. A system as recited in claim 1 wherein the second rotation means comprises a motor mounted on the base member for selectively rotating the patient support around the second rotation axis.

5. A system as recited in claim 1 wherein ω₁ and ω₂ are less than 50 rpm.

6. A system as recited in claim 1 wherein the patient support is a chair.

7. A system as recited in claim 1 further comprising a computer connected with the controller for operating the system in accordance with the predetermined protocol.

8. A system as recited in claim 7 wherein the predetermined protocol includes a sequence of movements according to an Epley maneuver.

9. A system as recited in claim 1 wherein the second rotation axis is perpendicular to the first rotation axis.

10. A system for repositioning canaliths in the inner ear of a patient using system generated acceleration forces, the system comprising:
a base member;
a connecting assembly;
a first motor mounted on the base member for rotating the connecting assembly at an angular velocity, ω₁, greater than 20 revolutions per minute (rpm);
a patient support;
a second motor mounted on the connecting assembly for rotating the patient support at an angular velocity, ω₂, greater than 20 rpm; and
a controller for activating the first and second motors to maneuver a patient from a first position to a second position and to generate acceleration forces exceeding the force of gravity to relocate canaliths in the inner ear of the patient.

11. A system as recited in claim 10 wherein the connecting assembly comprises:
a substantially U-shaped loop member having a first end and a second end with an attachment point established therebetween, wherein the first end and the second end of the loop member define a first rotation axis; and
a swivel drive for interconnecting the loop with the base member at the attachment point on the loop, wherein the swivel drive is oriented to facilitate rotation of the loop member about a second rotation axis, with the first rotation axis substantially perpendicular to the second rotation axis.

12. A system as recited in claim 10 wherein ω₁ and ω₂ are less than 50 rpm.

13. A system as recited in claim 10 wherein the patient support is a chair.

14. A system as recited in claim 10 wherein the first position and the second position are positions in a predetermined protocol and wherein the system further comprises a computer connected with the controller for operating the system in accordance with the predetermined protocol.

15. A system as recited in claim 14 wherein the predetermined protocol includes a sequence of movements according to an Epley maneuver.

16. A method for repositioning canaliths in the inner ear of a patient using Hyper-G acceleration forces, the method comprising the steps of:
mounting a connecting assembly on a base member;
mounting a patient support on the connecting assembly;
mounting a first motor on the base member to rotate the connecting assembly relative to the base member at an angular velocity, ω₁;
mounting a second motor on the connecting assembly for rotating the patient support at an angular velocity, ω₂;
positioning the patient on the patient support;
activating the first and second motors to maneuver the patient from a first position to a second position wherein the angular velocity, ω₁, and the angular velocity, ω₂, are each greater than 20 revolutions per minute (rpm) to relocate canaliths in the inner ear of the patient.

17. A method as recited in claim 16 wherein the connecting assembly comprises:
a substantially U-shaped loop member having a first end and a second end with an attachment point established therebetween, and wherein the first end and the second end of the loop member define a first rotation axis; and
a swivel drive for interconnecting the loop with the base member at the attachment point on the loop, wherein the swivel drive is oriented to facilitate rotation of the loop member about a second rotation axis, with the first rotation axis substantially perpendicular to the second rotation axis.

18. A method as recited in claim 16 wherein ω₁ and ω₂ are less than 50 rpm.

19. A method as recited in claim 16 wherein the first position and the second position are positions in a predetermined protocol and wherein the method further comprises the step of using a computer to manipulate the patient in accordance with the predetermined protocol.

20. A method as recited in claim 19 wherein the predetermined protocol includes a sequence of movements according to an Epley maneuver.
